(19) United States
(12) Patent Application Publication
(10) Pub. No.: US 2022/0022273 A1
(43) Pub. Date: Jan. 20, 2022

(54) METHODS FOR PUTTING A BUTTONLESS OR PERMANENTLY SEALED BLUETOOTH DEVICE INTO PAIRING, DISCOVERY, OR RESET MODE

(71) Applicant: L'OREAL, Paris (FR)

(72) Inventor: David B. Kosecoff, San Francisco, CA (US)

(73) Assignee: L'OREAL, Paris (FR)

(21) Appl. No.: 16/929,894

(22) Filed: Jul. 15, 2020

(51) Int. Cl. H04W 76/14; G06K 19/06; G06K 7/14; H04W 4/70

(52) U.S. Cl. CPC H04W 76/14; H04W 4/70; G06K 7/1417; G06K 19/06037

(57) ABSTRACT

A method for pairing a Bluetooth device and a smart device is disclosed herein. In some embodiments, the method includes emitting a sequence of light signals by a source of light of the smart device, detecting the sequence of light signals by a light detector of the Bluetooth device, and, if the sequence of light signals is recognized by the Bluetooth device, entering a pairing mode between the Bluetooth device and the smart device.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

Bluetooth communication is ubiquitous. Creating wireless networks that reduce the need for wired connections has wide-reaching commercial, industrial, and military applications, among others. Bluetooth has allowed development of a multitude of wearable devices, giving a user a freedom of motion without tripping hazards or being otherwise burdened by wires. Conventional methods for pairing Bluetooth devices require manually manipulating a button on the device to put the device into discovery mode, so that it can be paired with other devices.

As technology progresses, Bluetooth may be utilized in applications and environments where devices are waterproof, dustproof, permanently sealed, or otherwise too small or too impractical to have mechanical pairing means incorporated onto the device. Therefore, systems and methods are needed for improved pairing of Bluetooth devices.

In one embodiment, a method for pairing a Bluetooth device and a smart device includes: emitting a sequence of light signals by a source of light of the smart device; detecting the sequence of light signals by a light detector of the Bluetooth device; and if the sequence of light signals is recognized by the Bluetooth device, entering a pairing mode between the Bluetooth device and the smart device.

In another embodiment, the method includes scanning a visual ID pattern of the Bluetooth device by the smart device; and recognizing the visual ID pattern by the smart device. Emitting the sequence of light signals by the source of light of the smart device is based on the recognized visual ID pattern.

In one embodiment, the visual ID pattern is unique to a Bluetooth device. In another embodiment, the visual ID pattern is a QR code. In another embodiment, the visual ID pattern is a serial number. In yet another embodiment, the visual ID pattern is a barcode.

In one embodiment, the scanning of the visual ID pattern is executed with an application of the smart device.

In one embodiment, the method also includes placing the source of light of the smart device proximally to the light detector of the Bluetooth device.

In one embodiment, the sequence of light signals is unique to a Bluetooth device. In another embodiment, the source of light is the flashlight of the smart device.

In one embodiment, the light detector of the Bluetooth device includes: a photodiode; an aperture covering the photodiode; and a microcontroller that is operatively coupled to the photodiode.

In one embodiment, the method also includes emitting the sequence of light signals with an application on the smart device.

In one embodiment, a method for pairing a Bluetooth device and a smart device includes: periodically listening for a sequence of radio frequency (RF) signals by the Bluetooth device; emitting the sequence of RF signals by an antenna of the smart device; detecting the sequence of RF signals by an antenna of the Bluetooth device; and if the sequence of RF signals is recognized by the Bluetooth device, entering a pairing mode between the Bluetooth device and the smart device.

In another embodiment, the method also includes: scanning a visual ID pattern of the Bluetooth device by the smart device; and recognizing the visual ID pattern. The predetermined sequence of RF signals emitted by the smart device is based on the recognized visual ID pattern.

In one embodiment, the predetermined sequence of RF signals emitted by the smart device is unique to the specific Bluetooth device.

In one embodiment, the visual ID pattern in unique to the specific Bluetooth device. In another embodiment, the visual ID pattern is a QR code. In another embodiment, the visual ID pattern is a serial number. In yet another embodiment, the visual ID pattern is a barcode.

In one embodiment, the Bluetooth device is buttonless or sealed.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1A is a schematic diagram of an example Bluetooth device in accordance with the present technology;

FIG. 1B illustrates interactions between an example Bluetooth device and a smart device in accordance with the present technology;

FIG. 2A is a schematic diagram of an example Bluetooth device in accordance with the present technology;

FIG. 2B illustrates an interaction between an example Bluetooth device and a smart device in accordance with the present technology;

FIG. 3 is a flowchart of a method of placing a Bluetooth device into pairing mode in accordance with the present technology;

FIG. 4A is a schematic diagram of an example Bluetooth device in accordance with the present technology;

FIG. 4B is an embodiment of an example smart device in accordance with the present technology;

FIG. 5 is a flowchart of a method of placing a Bluetooth device into pairing mode in accordance with the present technology.

### DETAILED DESCRIPTION

While illustrative embodiments have been illustrated and described, it will be appreciated that various changes can be made therein without departing from the spirit and scope of the invention.

In some embodiments, the inventive technology includes a Bluetooth device with a visual ID pattern. In some embodiments, the Bluetooth device is relatively small, therefore not having space for a Bluetooth pairing button. In other embodiments, the Bluetooth device may be permanently sealed, therefore also not having accessible commands or points that can be used during the Bluetooth pairing. In some embodiments, a smart device scans the visual ID pattern in order to recognize the Bluetooth device. If the smart device recognizes the Bluetooth device, then the smart device can initiate pairing. In the context of this disclosure, wireless connections that transfer data between two pared devices are referred to as Bluetooth connections. However, it should be understood that other wireless technologies, e.g., WiFi, LTE, etc., may be used with the inventive technology.

In other embodiments, the inventive technology includes a Bluetooth device with a light detector. In some embodiments, the smart device sends a light pattern to the light detector through a light source on the smart device. In some embodiments, this light pattern puts the Bluetooth device into pairing mode.

In other embodiments, the present invention includes a Bluetooth device with an antenna. In operation, a smart device sends an RF signal through an antenna on the smart device. In some embodiments, when the antenna on the Bluetooth device receives the RF signal, the Bluetooth device is placed into pairing mode.

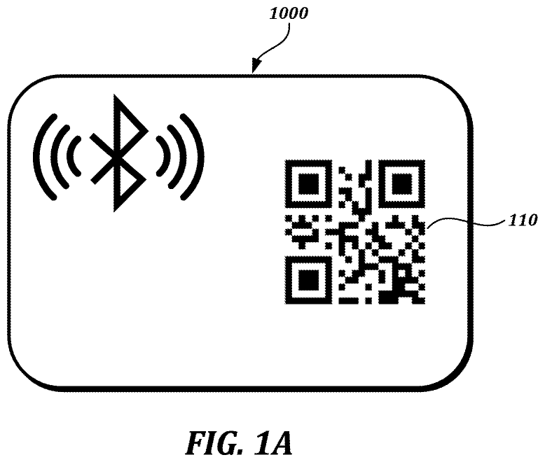

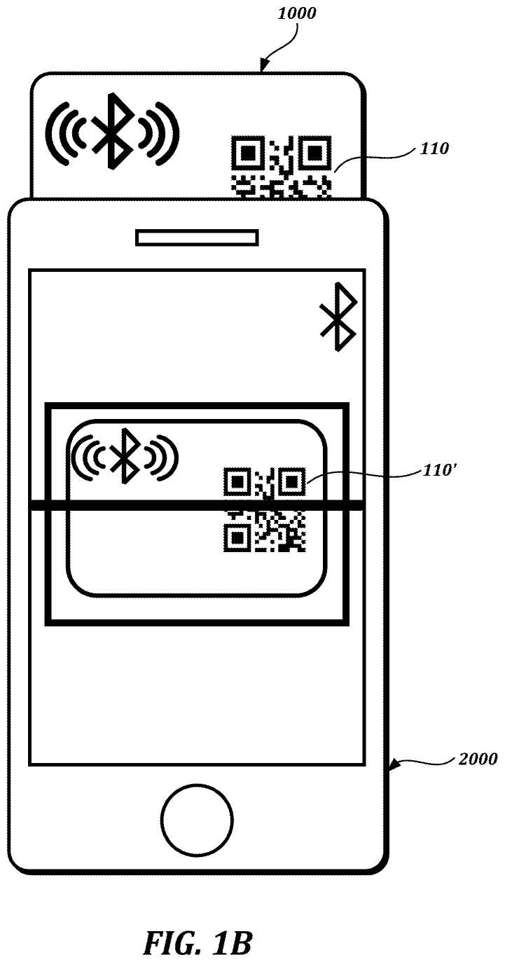

FIG. 1A is an example Bluetooth device in accordance with the present technology. The Bluetooth device 1000 includes a visual ID pattern 110. In the illustrated embodiment, the visual ID pattern 110 is a QR code. In other embodiments, the visual ID pattern 110 may be a barcode, a serial number, or other graphic representation.

The visual ID pattern 110 may be unique to a Bluetooth device 1000. In other embodiments, the visual ID pattern 110 may be the same for other Bluetooth devices 1000 of the same model or type. In some embodiments, the visual ID pattern 110 is printed on the Bluetooth device 1000. In other embodiments, the visual ID pattern 110 is etched on the Bluetooth device 1000. Some non-limiting examples of the Bluetooth devices 1000 are a wearable UV or Blue Light sensor, a wearable pollution (e.g., NO2, PM2.5, etc.) sensor, a wearable sweat monitor, a wearable pH monitor, a wearable temperature monitor, a wearable glucose monitor, a personal nametag/bib tag, a wearable activity monitor, an asset-tracking tag, a proximity marketing beacon, and a navigation beacon. In some embodiments, these Bluetooth devices may be single-use (e.g., disposable, non-rechargeable, non-battery replaceable, etc.).

FIG. 1B illustrates an example interaction between a Bluetooth device 1000 and a smart device (or host device) 2000. The Bluetooth device 1000 includes a visual ID pattern 110. The smart device 2000 is illustrated as a cellphone but in other embodiments, the smart device 2000 takes the form of any number of other computing devices such as a smart watch, a tablet, and the like.

In operation, the Bluetooth device 1000 is in a listening mode by default. The pairing operation may proceed as follows. The smart device 2000 scans the visual ID pattern 110 on the Bluetooth device 1000 by aligning the Bluetooth device 1000 with the camera of the smart device 2000. As illustrated, the user may align the visual ID pattern 110′ on the interface of the smart device 2000 with a scanner of the application. For example, the smart device 2000 scans the visual ID pattern 110, and if it recognizes the visual ID pattern 110, then the smart device 2000 initiates pairing.

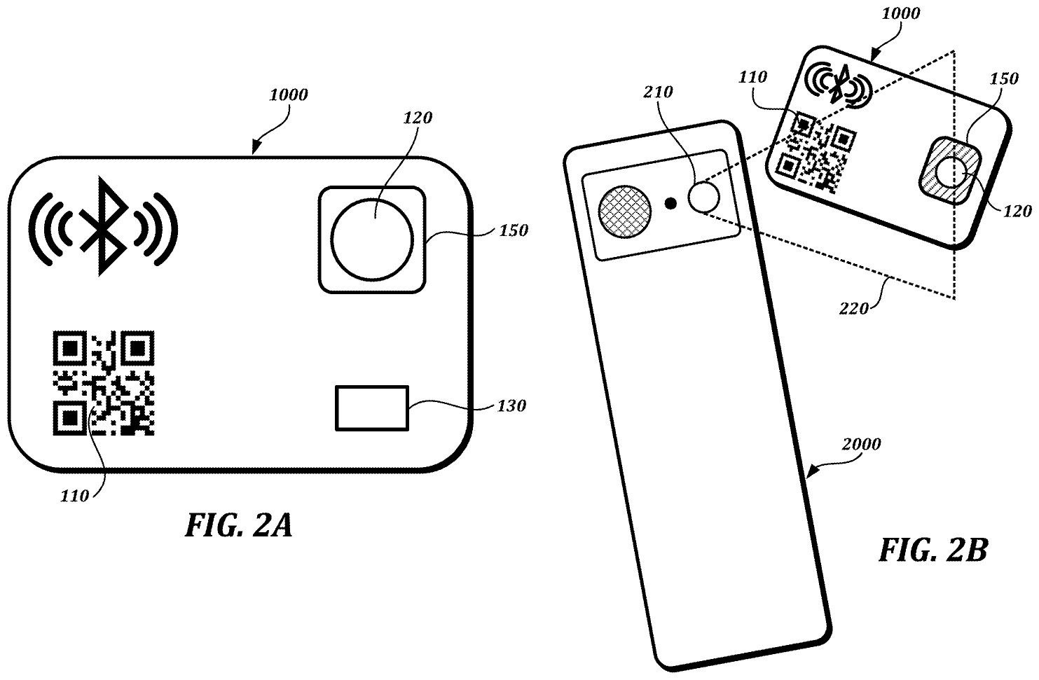

FIG. 2A is a schematic diagram of an example Bluetooth device in accordance with the present technology. The Bluetooth device 1000 includes a visual ID pattern 110, a microcontroller 130, an aperture (e.g., a transparent cover) 150, and a light detector 120. In some embodiments, the light detector 120 is a photodiode. In some embodiments, the aperture 150 is made of glass. In other embodiments, the aperture 150 is made of another transparent material, such as plastic.

In operation, the aperture 150 allows detection of light by the light detector 120. The microcontroller 130 may continuously monitor voltage across the light detector 120. When the microcontroller 130 detects a certain sequence of voltages across the light detector 120, it sets the Bluetooth device 1000 into a pairing (or discovery) mode, as further described with reference to FIG. 2B below.

FIG. 2B illustrates interactions between a Bluetooth device 1000 and a smart device 2000. The Bluetooth device 1000 includes a visual ID pattern 110 and an aperture 150. The smart device 2000 includes a source of light 210 that is illustrated as the flashlight of a smart device 2000, but in other embodiments, the source of light 210 may take other forms, such as an LED.

In operation, the smart device 2000 relies on an application that controls the source of light 210. In some embodiments, the application recognizes a variety of Bluetooth devices 1000 through their unique visual ID pattern 110. In other embodiments, the application is tailored for the specific model or type of Bluetooth device 1000.

Once the smart device 2000 has recognized the Bluetooth device 1000, the smart device may broadcast light 220 in a specific sequence. The aperture 150 allows for the light 220 to be detected by the light detector 120. In some embodiments, the light detector 120 is a photodiode. The microcontroller 130 monitors the voltage across the light detector 120. In some embodiments, the microcontroller 130 monitors the voltage continuously, but in other embodiments, the microcontroller 130 monitors the voltage sporadically, or periodically. When the microcontroller 130 detects the specific sequence of light 220, it sets the Bluetooth device 1000 into pairing or discovery mode.

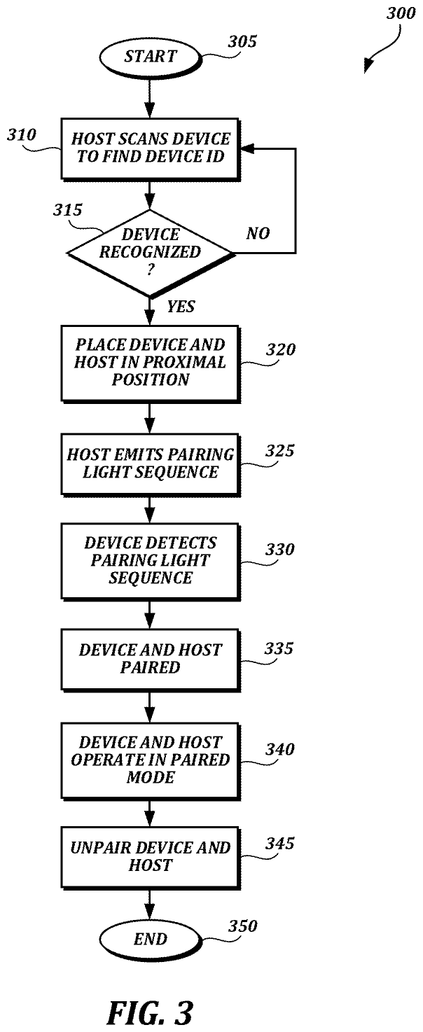

FIG. 3 is a flowchart of a method of putting a Bluetooth device into pairing mode in accordance with the present technology. In some embodiments, the method may include additional steps or may be practiced without all steps illustrated in the flow chart.

The method 300 begins at block 305. In block 310, the host device (e.g., the smart device 2000) scans the visual ID pattern on the Bluetooth device. In block 315, if the Bluetooth device is recognized, and the method proceeds to block 320. If the Bluetooth device is not recognized, the method returns to block 310 and the host device scans the visual ID pattern again, until it recognizes the Bluetooth device.

In block 320, the user places the Bluetooth device and the host device in proximally to each other. In some embodiments, the user aligns the flashlight or light source of the host device with the aperture on the Bluetooth device. In block 325, the host device emits a pairing light sequence. In some embodiments, the pairing light sequence is unique to the individual Bluetooth device. In other embodiments, the pairing light sequence is unique to the type of Bluetooth device.

In block 330, the Bluetooth device detects the pairing light sequence by, for example, the light detector 120. In block 335, the Bluetooth device and the host device are paired. In block 340, the Bluetooth device and the host device operate in paired mode. Eventually, when the user is finished with the Bluetooth device, in block 345, the Bluetooth device and the host device are unpaired. In block 350, the method ends.

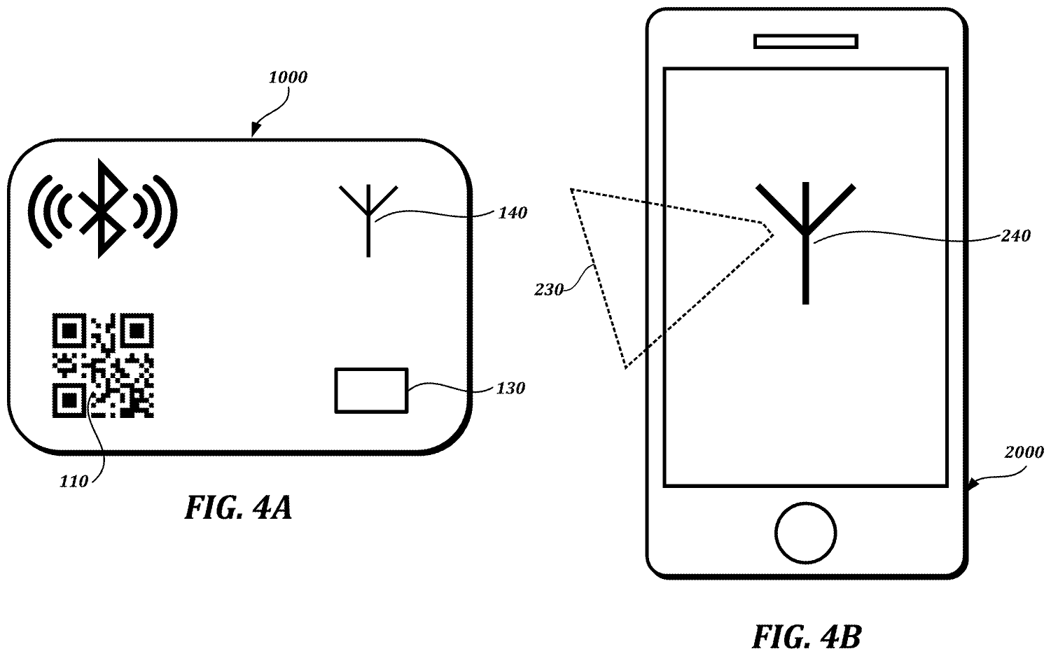

FIG. 4A is an example Bluetooth device 1000 in accordance with the present technology. In the illustrated embodiment, the Bluetooth device 1000 includes an antenna 140, a microcontroller 130, and a visual ID pattern 110. In operation, the antenna 140 detects a radio frequency (RF) signal 230 that is transmitted by the smart device (as illustrated in FIG. 4B). The microcontroller 130 attached to the antenna 140 monitors whether the antenna 140 has received the RF signal 230. In some embodiments, the microcontroller 130 listens periodically for a sequence of RF signals. In other embodiments, the microcontroller 130 continuously listens for the sequence of RF signals.

FIG. 4B is an example smart device 2000 in accordance with the present technology. The smart device 2000 includes an antenna 240. In some embodiments, the visual ID pattern 110 of the Bluetooth device 1000 is detected by the smart device 2000 as described above with respect to FIGS. 1A and 1B. In operation, with an application on the smart device 2000, the antenna 240 transmits an RF signal 230. The antenna 140 on the Bluetooth device 1000 receives the RF signal 230, and the microcontroller 130 puts the Bluetooth device into pairing mode.

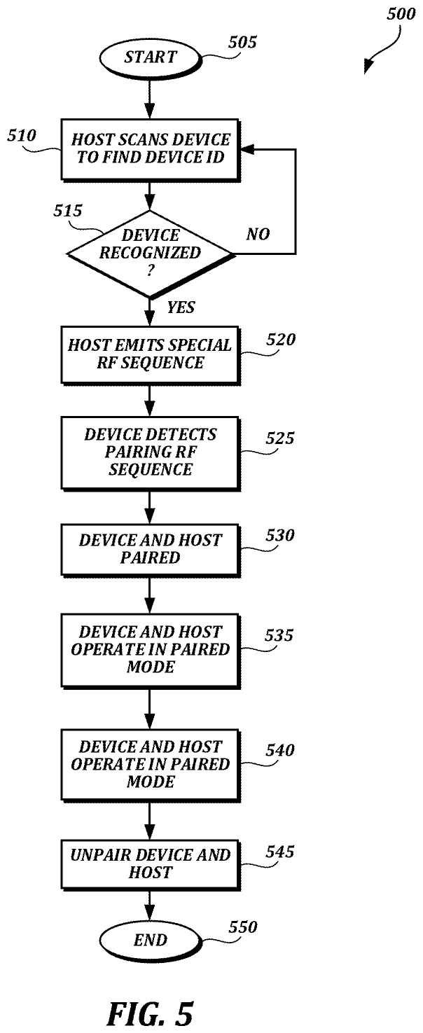

FIG. 5 is a flowchart of a method of placing a Bluetooth device into pairing mode in accordance with the present technology. In some embodiments, the method may include additional steps or may be practiced without all steps illustrated in the flow chart.

The method 500 starts at block 505. In block 510, the host device (e.g., the smart device 2000) scans the Bluetooth device's visual ID pattern. In block 515, if the Bluetooth device is recognized, the method proceeds to block 520. If the Bluetooth device is not recognized, the method returns to block 510 and the host device scans the visual ID pattern again, until it recognizes the Bluetooth device.

In block 520, the host device emits a special RF sequence through its antenna. In some embodiments, the RF sequence is unique to the specific Bluetooth device. In other embodiments, the RF sequence is unique to the type of Bluetooth device. In block 525, the Bluetooth device detects the RF sequence transmitted by the smart device. In block 530, the Bluetooth device and the host device are paired.

In block 540, the Bluetooth device and the host device operate in paired mode. Eventually, when the user is finished with the Bluetooth device, in block 545, the Bluetooth and the host device are unpaired. In block 550, the method ends.

Many embodiments of the technology described above may take the form of computer- or controller-executable instructions, including routines executed by a programmable computer or controller. Those skilled in the relevant art will appreciate that the technology can be practiced on computer/controller systems other than those shown and described above. The technology can be embodied in a special-purpose computer, controller or data processor that is specifically programmed, configured or constructed to perform one or more of the computer-executable instructions described above. Accordingly, the terms “computer” and “controller” as generally used herein refer to any data processor and can include Internet appliances and hand-held devices (including palm-top computers, wearable computers, cellular or mobile phones, multi-processor systems, processor-based or programmable consumer electronics, network computers, mini computers and the like).

From the foregoing, it will be appreciated that specific embodiments of the technology have been described herein for purposes of illustration, but that various modifications may be made without deviating from the disclosure. For example, in some embodiments the counter or controller may be based on a low-power buck regulator connected to a capacitor. Moreover, while various advantages and features associated with certain embodiments have been described above in the context of those embodiments, other embodiments may also exhibit such advantages and/or features, and not all embodiments need necessarily exhibit such advantages and/or features to fall within the scope of the technology. Accordingly, the disclosure can encompass other embodiments not expressly shown or described herein.

The present application may also reference quantities and numbers. Unless specifically stated, such quantities and numbers are not to be considered restrictive, but exemplary of the possible quantities or numbers associated with the present application. Also, in this regard, the present application may use the term “plurality” to reference a quantity or number. In this regard, the term “plurality” is meant to be any number that is more than one, for example, two, three, four, five, etc. The terms “about,” “approximately,” etc., mean plus or minus 5% of the stated value.

The principles, representative embodiments, and modes of operation of the present disclosure have been described in the foregoing description. However, aspects of the present disclosure, which are intended to be protected, are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure as claimed.

What is claimed is:

1. A method for pairing a Bluetooth device and a smart device, the method comprising:
emitting a sequence of light signals by a source of light of the smart device;
detecting the sequence of light signals by a light detector of the Bluetooth device; and
if the sequence of light signals is recognized by the Bluetooth device, entering a pairing mode between the Bluetooth device and the smart device.

2. The method of claim 1, further comprising:
scanning a visual ID pattern of the Bluetooth device by the smart device; and
recognizing the visual ID pattern by the smart device,
wherein the emitting the sequence of light signals by the source of light of the smart device is based on the recognized visual ID pattern.

3. The method of claim 2, wherein the visual ID pattern is unique to a Bluetooth device.

4. The method of claim 2, wherein the visual ID pattern is a QR code.

5. The method of claim 2, wherein the visual ID pattern is a serial number.

6. The method of claim 2, wherein the visual ID pattern is a barcode.

7. The method of claim 2, wherein the scanning of the visual ID pattern is executed with an application of the smart device.

8. The method of claim 1, further comprising:
placing the source of light of the smart device proximally to the light detector of the Bluetooth device.

9. The method of claim 1, wherein the sequence of light signals is unique to a Bluetooth device.

10. The method of claim 1, wherein the source of light is the flashlight of the smart device.

11. The method of claim 1, wherein the light detector of the Bluetooth device comprises:
a photodiode;
an aperture covering the photodiode; and
a microcontroller that is operatively coupled to the photodiode.

12. The method of claim 1, wherein the method further comprises:
emitting the sequence of light signals with an application on the smart device.

13. A method for pairing a Bluetooth device and a smart device, the method comprising:
periodically listening for a sequence of radio frequency (RF) signals by the Bluetooth device;
emitting the sequence of RF signals by an antenna of the smart device;
detecting the sequence of RF signals by an antenna of the Bluetooth device; and
if the sequence of RF signals is recognized by the Bluetooth device, entering a pairing mode between the Bluetooth device and the smart device.

14. The method of claim 13, further comprising:
scanning a visual ID pattern of the Bluetooth device by the smart device; and
recognizing the visual ID pattern,
wherein the predetermined sequence of RF signals emitted by the smart device is based on the recognized visual ID pattern.

15. The method of claim 13, wherein the predetermined sequence of RF signals emitted by the smart device is unique to the specific Bluetooth device.

16. The method of claim 14, wherein the visual ID pattern in unique to the specific Bluetooth device.

17. The method of claim 14, wherein the visual ID pattern is a QR code.

18. The method of claim 14, wherein the visual ID pattern is a serial number.

19. The method of claim 14, wherein the visual ID pattern is a barcode.

20. The method of claim 14, wherein the Bluetooth device is buttonless or sealed.
